(19) United States
(12) Patent Application Publication
(10) Pub. No.: US 2003/0014435 A1
(43) Pub. Date: Jan. 16, 2003

(54) Generic method of routing through an object tree to invoke a specific method for certain objects of said tree

(76) Inventors: Sylvain Devillers, Paris (FR); Myrian C. Amielh-Caprioglio, Paris (FR)

Correspondence Address: Corporate Patent Counsel, U.S. Philips Corporation, 580 White Plains Road, Tarrytown, NY, 10591, US

(21) Appl. No.: 10/127,479

(22) Filed: Apr. 22, 2002

(30) Foreign Application Priority Data
Jul. 10, 2001 (FR) 0109167

(51) Int. Cl. G06F 15/00

(52) U.S. Cl. 707/500

(57) ABSTRACT

The invention consists of defining a generic class and a plurality of specific classes which extend from said generic class. Said specific classes are intended to be made into instances for the generation of an object tree. The generic class comprises a generic method of invoking a specific method of a specific class for the objects of the tree which are instances of this specific class. For a current object of the tree the generic method invokes said specific method if the current object is an instance of said specific class and it is recursively executed for the variables of the current object which are instances of one of said specific classes.

### FIELD OF THE INVENTION

The invention relates to a method of passing through a tree which contains objects which are instances of one or more specific classes with a view to invoking a specific method of one of said specific classes for the objects of said tree which are instances of said specific class.

The invention also relates to a data structure written in an object programming language which comprises one or more specific classes intended to be instantiated for the generation of an object tree, at least one of said specific classes comprising at least one specific method.

The invention also relates to a document written in an object programming language which comprises objects that are instances of specific classes defined in such a data structure.

The invention also relates to a program written in an object programming language, comprising instructions for handling such a document when it is executed by a processor.

The invention also relates to electronic equipment comprising a memory which contains such a program, such a document or such a data structure.

The invention also relates to a signal which transports such a program, such a document or such a data structure.

The invention has many applications particularly for processing document models.

### BACKGROUND OF THE INVENTION

Such an object tree is described, for example, in the specification “Document Object Model (DOM), level 1 specification, version 1.0, Oct. 1 1998” defined by the W3C consortium for modeling documents of the HTML or XML type.

When such an object tree is handled, it is often necessary to pass through the tree to execute a specific method for certain objects. It is an object of the invention to propose a particularly efficient solution for passing through a tree comprising objects that are instances of one or more specific classes so as to invoke a specific method of one of said specific classes for the objects of said tree which objects are instances of this specific class.

### SUMMARY OF THE INVENTION

This object is achieved with a method of passing through a tree of objects as claimed in one of the claims 1 or 2 of the present application, with a data structure as claimed in claim 3, a document as claimed in claim 4 and a program as claimed in claim 5.

The invention notably consists of dissociating the routing through the tree from the execution of specific methods. In fact, according to the invention, the generic method of invoking a specific method has for its function to route through the tree and invoke said specific method when it meets an object for which this method must be invoked. The specific methods carry out a specific processing for a current object. They do not manage the navigation in the tree.

The invention thus permits to simplify the writing of data structures in which the route through a tree of objects is to be managed for the execution of certain methods for certain objects of the tree.

### BRIEF DESCRIPTION OF THE DRAWINGS

These and other aspects of the invention are apparent from and will be elucidated, by way of non-limitative example, with reference to the embodiment(s) described hereinafter.

In the drawings:

FIG. 1 is a diagrammatic representation of a data structure according to the invention,

FIG. 2 gives an example of a tree that is generated in that the data structure represented in FIG. 1 is made into instances,

FIG. 3 is a block diagram of an example of a method according to the invention,

FIG. 4 is an example of equipment according to the invention which may receive signals, notably transport signals of a program or of a document according to the invention, and having a memory for storing such a program, such a document and such a data structure.

### DESCRIPTION OF PREFERRED EMBODIMENTS

In a general way a data structure according to the invention comprises a generic class GC and a plurality of specific classes SC_{i (i=1, . . . ,N)}. Each class may comprise one or various instance variables notably instance variables of the object type. An instance variable of the object type is formed by an object or a table of objects that are instances of a specific class. A data structure according to the invention is defined so that its implementation generates a tree TR of objects obᵢ.

According to the invention one or various specific classes SC_{I} comprise a specific method sMᵢ. The specific methods sM_{I} have any number of arguments P_{I,j} (where j is any natural integer). The generic class GC comprises a generic method gM of invoking a specific method sM_{I} of a specific class SC_{I} for the objects ob_{I} of the tree TR which are instances of said specific class SCᵢ. The specific classes SC_{I} extend from this generic class GC, so that they implicitly contain the generic method gM. To execute the generic method gM, the following arguments are to be specified:

the specific method sM_{I} to be invoked,

the specific class SC_{I} whose objects ob_{I} for which the specific method sM_{I} is to be invoked are instances,

the arguments P_{i,j} of the method sM_{I}, when it has any.

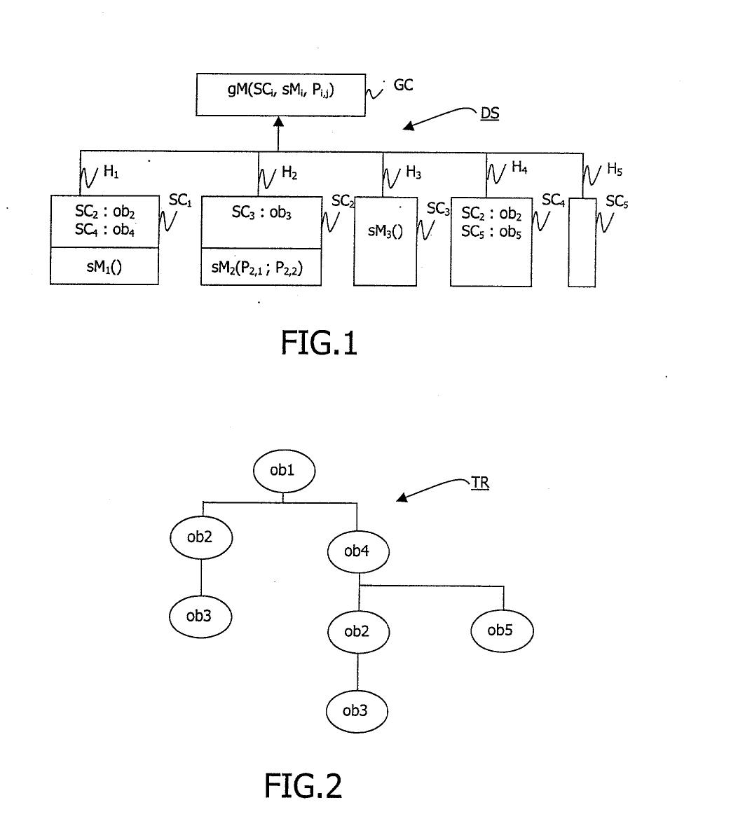

In FIG. 1 is represented in diagrammatic manner an example of such a data structure. According to FIG. 1 the data structure DS comprises a generic class GC and five specific classes referred to as SC₁, SC₂, SC₃, SC₄ and SC₅. The specific class SC₁ comprises two instance variables which are instance objects of the specific classes SC₂ and SC₄, respectively. These objects are numbered ob₂ and ob₄, respectively. The specific class SC₂ comprises an instance variable which is an instance object of the specific class SC₃ and which is numbered ob₃. The specific class SC₄ finally comprises two instance variables which are instance objects of the specific classes SC₂ and SC₅, respectively, and which are numbered ob₂ and ob₅, respectively.

FIG. 2 shows an example of a tree TR which forms an instance of the data structure DS defined with respect to FIG. 1. This tree TR comprises an object ob₁ which points to a first object ob₂ and to an object ob₄. The first object ob₂ is a first instance of the class SC₂. The object ob₄ is an instance of the class SC₄. The first object ob₂ points to a first object ob₃ which is a first instance of the class SC₃. The object ob₄ points to a second object ob₂ which is a second instance of the class SC₂, and to an object ob₅ which is an instance of the class SC₅. The second object ob₂ points to a second object ob₃ which is a second instance of the class SC₃.

According to FIG. 1 the generic class GC comprises a generic method called gM(SCᵢ, sMᵢ, P_{i,j}) which is a generic method of invoking a specific method sMᵢ for the objects of the tree TR which are instances of a specific class SCᵢ. When the generic method gM is executed for invoking a specific method sMᵢ that has one or more arguments P_{i,j}, this or these arguments P_{i,j} are specified as arguments of the generic method gM. The specific classes sMᵢ (i=1, . . . , 5) extend from the generic class GC: in FIG. 1 this relationship is symbolized by the arrows H_{i (i=1, . . . , 5)}. The specific classes SC₁, SC₂ and SC₃ comprise each a specific method denoted sM₁, sM₂ and sM₃, respectively. The specific method sM₂ has two arguments denoted P_{2,1} and P_{2,2}, respectively. The other specific methods sM₁ and sM₃ do not have arguments.

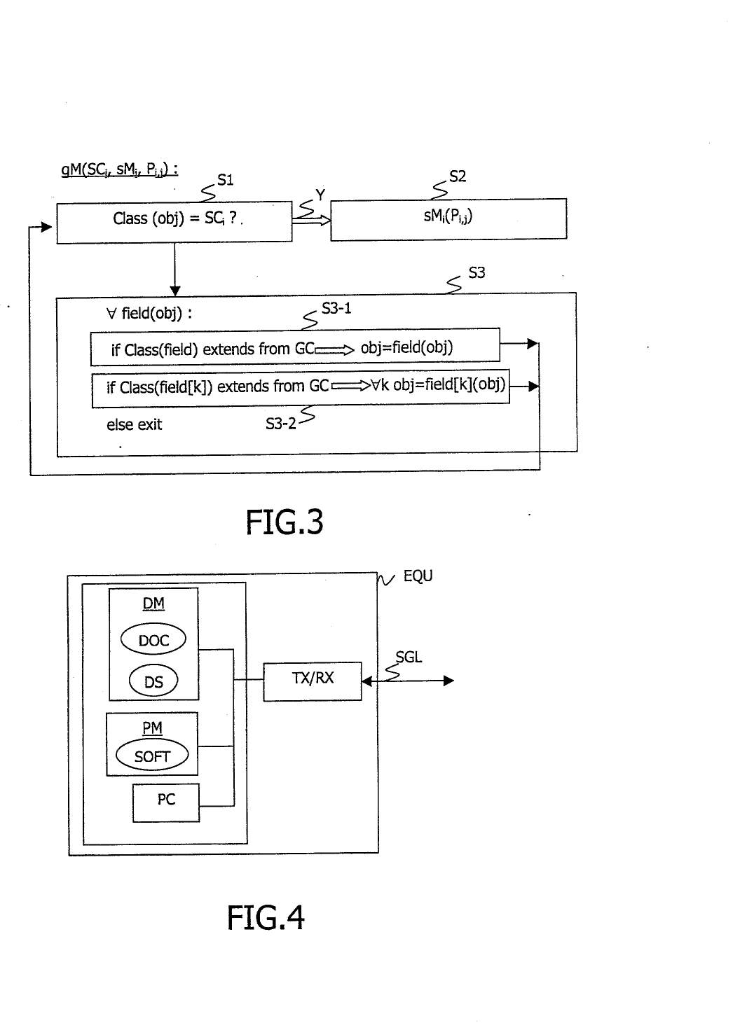

In FIG. 3 is represented a flowchart of a generic method gM(SCᵢ, sMᵢ, P_{i,j}) of routing through a tree to invoke the specific method sMᵢ for the objects of said tree which are instances of the specific class SCᵢ. This generic method consists of routing through the tree from its root and carrying out the following steps for a current object of the tree denoted obj:

step S1: test to determine whether the current object obj is an instance of the specific class SCᵢ (“Class(obj)=SCᵢ?”)

step S2: if the current object is an instance of the class SCᵢ (arrow Y), invocation of the specific method sMᵢ(P_{i,j})

step S3: routing through the instance variables (field) of the current object obj and for each instance variable:

if the instance variable is an instance object of a class extending from the generic class GC (“Class(field) extends from GC”), recursive execution of the generic method gM(SCᵢ, sMᵢ, P_{i,j}) for this object (step S3-1)

if the instance variable is a table of instance objects of a class extending from the generic class GC (“Class(field[k]) extends from GC”), recursive execution of the generic method gM(SCᵢ, sMᵢ, P_{i,j}) for each object (step S3-2).

The invention is notably applied for the processing of document models, for example, for the processing of an XML diagram model which describes the format of an XML document (XML diagram and XML are a recommendation project and a recommendation, respectively, of the W3C consortium, available, for example, on the Internet site http://www.w3.org). Such a diagram constitutes a tree of objects called elements which are instances of a class “Element”. An Element may comprise one or various other elements. For each Element the diagram notably defines a name and a type. Generally, to simplify the description of the diagram, numbered types are used. A numbered type is defined once and for all in the diagram and it is then called by its name. If one wishes to utilize such a diagram, it is necessary to resolve the types of the elements it contains, that is to say, to search for the definition of the named type of each element found. For this purpose the class Element comprises a type resolving method “resolveElementType”.

This method is advantageously a specific method in the sense of the present invention. The class Element is then a specific class in the sense of the invention which extends from a generic class. This generic class comprises a generic method of invoking a specific method. This generic method is executed for each element of the diagram to invoke the type resolving method “resolveElementType”. The data structure in which are defined the specific class “Element” and the generic class from which it extends is thus a data structure according to the invention. Similarly, the diagram is a document according to the invention and any program that handles this diagram is a program according to the invention.

By applying the invention it is avoided having to manage the routing through the tree in the main part of the method of resolving the type.

The generic method thus defined is advantageously utilized for invoking other specific methods which would be defined in the class Element, for example, a specific display method “printName” of the name of the elements of the diagram, utilized for debugging said diagram.

FIG. 4 shows a diagram of electronic equipment EQU comprising:

a microprocessor assembly MP which notably comprises a data memory DM, a program memory PM and a processor PC which make it possible to execute the programs stored in the program memory PM.

a transmission device TX/RX permitting to receive signals, notably signals that transport programs.

When the equipment EQU receives a signal SGL that transports a program SOFT according to the invention, this program SOFT is stored in the program memory PM. When the equipment EQU receives a signal SGL that transports a data structure DS according to the invention and/or a document DOC according to the invention, this data structure DS and/or this document DOC are stored in the data memory DM.

1. A method of passing through a tree (TR) which contains objects (ob) which are instances of one or more specific classes (SCᵢ) with a view to invoking a specific method (sMᵢ) of one of said specific classes for the objects of said tree which are instances of said specific class, characterized in that the method consists of defining a generic class (GC) from which said specific classes extend, which comprises a generic method (gM(SCᵢ, sMᵢ, P_{i,j})) of invoking a specific method (sMᵢ) for an object which is an instance of a specific class (SCᵢ), and which method, when executed for a current object, consists of invoking said specific method if the current object is an instance of said specific class, and of being recursively executed for the variables of the current object which are instances of one of said specific classes.

2. A method as claimed in claim 1, characterized in that, when said generic method is executed to invoke a specific method having one or more arguments (P_{i,j}), the argument or arguments of said specific method are specified as arguments of said generic method.

3. A data structure (DS) written in an object programming language, comprising one or more specific classes (SCᵢ) intended to be instantiated for generating a tree (TR) of objects (ob), at least one of said specific classes comprising at least a specific method (sMᵢ), characterized in that the data structure (DS) comprises a generic class (GC) from which said specific classes extend, which generic class (GC) comprises a generic method (gM(SCᵢ, sMᵢ, P_{i,j})) of invoking a specific method for an object which is an instance of a specific class, and which, when executed for a current object, consists of invoking said specific method if the current object is an instance of said specific class, and of being recursively executed for the variables of the current object which are instances of one of said specific classes.

4. A document (DOC) written in an object programming language which comprises objects that are instances of specific classes defined in a data structure as claimed in claim 3.

5. A program (SOFT) written in an object programming language, comprising instructions for handling a document as claimed in claim 4 when it is executed by a processor.

6. Electronic equipment (EQU) comprising a memory (PM) that contains a program (SOFT) as claimed in claim 5.

7. Electronic equipment (EQU) comprising a memory (DM) that contains a data structure as claimed in claim 3.

8. Electronic equipment (EQU) comprising a memory (DM) that contains a document as claimed in claim 4.

9. A signal (SGL) transporting a program as claimed in claim 5.

10. A signal (SGL) transporting a document as claimed in claim 4.
